(19) United States
(12) Patent Application Publication
(10) Pub. No.: US 2015/0287406 A1
(43) Pub. Date: Oct. 8, 2015

(54) Estimating Speech in the Presence of Noise

(71) Applicant: Google Inc., (US)

(72) Inventors: Trausti T. Kristjansson, Mountain View, CA (US); Mitchel Weintraub, Mountain View, CA (US)

(73) Assignee: Google Inc., Mountain View, CA (US)

(21) Appl. No.: 13/771,419

(22) Filed: Feb. 20, 2013

Related U.S. Application Data
(60) Provisional application No. 61/615,025, filed on Mar. 23, 2012.

(51) Int. Cl. G10L 15/20

(52) U.S. Cl. CPC G10L 15/20

(57) ABSTRACT

A method for estimating speech signal in the presence of non-stationary noise includes determining a plurality of initial speech estimates by subtracting a plurality of noise spectra, respectively, from an observed spectrum. Each of the noise spectra is represented by a noise component vector obtained from a Gaussian mixture model. The method also includes determining a plurality of initial noise estimates by subtracting a plurality of speech spectra, respectively, from the observed spectrum. Each of the speech spectra is represented by a speech component vector obtained from another Gaussian mixture model. A plurality of scores is determined, each score corresponding to one of the plurality of initial speech estimates, and calculated from a joint distribution defined by a combination of one of the noise component vectors and one of the speech component vectors. A clean speech estimate is determined as a combination of a subset of the scores.

### CROSS REFERENCE TO RELATED APPLICATION

This application claims priority to U.S. provisional application No. 61/615,025, filed on Mar. 23, 2012, the entire content of which is incorporated herein by reference.

### BACKGROUND

This disclosure generally relates to speech recognition in noisy environments, e.g., to produce textual content for one or more applications executed by a computing device.

Speech recognition can be considered to potentially free a user from the laborious and somewhat monotonous practice of entering individual characters into the keyboard to provide a computing device with textual content for use in one or many applications (e.g., provide text to a word processor, commands for use with various applications, etc.). However, speech recognition performance degrades in noisy environments, for example in the presence of background music or machinery noise.

### SUMMARY

In one aspect, a method for estimating speech signal in the presence of non-stationary noise includes determining a plurality of initial speech estimates by subtracting a plurality of noise spectra, respectively, from an observed spectrum. Each of the noise spectra is represented by a noise component vector obtained from a Gaussian mixture model representing the noise. The method also includes determining a plurality of initial noise estimates by subtracting a plurality of speech spectra, respectively, from the observed spectrum, wherein each of the speech spectra is represented by a speech component vector obtained from a Gaussian mixture model representing speech. The method further includes determining a plurality of scores, wherein each score corresponds to one of the plurality of initial speech estimates. Each score is calculated from a joint distribution defined by a combination of one of the noise component vectors and one of the speech component vectors. The method also includes determining a clean speech estimate as a combination of at least a subset of the plurality of scores. A weight associated with a given score is the corresponding initial speech estimate that corresponds to the score.

In another aspect, a system includes a speech recognition engine. The speech recognition engine is configured to determine a plurality of initial speech estimates by subtracting a plurality of noise spectra, respectively, from an observed spectrum, wherein each of the noise spectra is represented by a noise component vector obtained from a Gaussian mixture model representing the noise. The speech recognition engine is also configured to determine a plurality of initial noise estimates by subtracting a plurality of speech spectra, respectively, from the observed spectrum, wherein each of the speech spectra is represented by a speech component vector obtained from a Gaussian mixture model representing speech. The speech recognition engine is further configured to determine a plurality of scores, wherein each score corresponds to one of the plurality of initial speech estimates and wherein each score is calculated from a joint distribution defined by a combination of one of the noise component vectors and one of the speech component vectors, and determine a clean speech estimate as a combination of at least a subset of the plurality of scores. A weight associated with a given score is the corresponding initial speech estimate that corresponds to the score.

In another aspect, a computer program product includes computer readable instructions tangibly embodied in a storage device. The instructions are configured to cause one or more processors to determine a plurality of initial speech estimates by subtracting a plurality of noise spectra, respectively, from an observed spectrum, wherein each of the noise spectra is represented by a noise component vector obtained from a Gaussian mixture model representing the noise. The instructions are also configured to cause the one or more processors to determine a plurality of initial noise estimates by subtracting a plurality of speech spectra, respectively, from the observed spectrum, wherein each of the speech spectra is represented by a speech component vector obtained from a Gaussian mixture model representing speech. The instructions are further configured to cause the one or more processors to determine a plurality of scores, wherein each score corresponds to one of the plurality of initial speech estimates and wherein each score is calculated from a joint distribution defined by a combination of one of the noise component vectors and one of the speech component vectors, and determine a clean speech estimate as a combination of at least a subset of the plurality of scores. A weight associated with a given score is the corresponding initial speech estimate that corresponds to the score.

Implementations can include one or more of the following. The observed spectrum can be represented by a vector that represents a frequency domain representation of a segment of a received speech signal. The observed spectrum vector can be obtained by dividing the received speech signal into segments of a predetermined duration, and computing an N point transform (such as an N point Fourier transform) for a segment to obtain the observed signal vector, where N is an integer. The noise component vector can be a mean vector of the Gaussian mixture model representing the noise. The speech component vector can be a mean vector of the Gaussian mixture model representing speech. The Gaussian mixture model representing speech can be estimated, such that the number of component distributions in the Gaussian mixture model representing speech is equal to or greater than the number of speech spectra used in determining the plurality of initial noise estimates. The Gaussian mixture model representing the noise can be estimated, such that the number of component distributions in the Gaussian mixture model representing noise is equal to or greater than the number of noise spectra used in determining the plurality of initial speech estimates. The clean speech estimate can be determined by normalizing the weighted combination by a sum of the subset of the plurality of scores. The joint distribution can be represented as a product of a first distribution represented by the corresponding speech component vector and a second distribution represented by the corresponding noise component vector. The score can be evaluated as a product of a distribution value corresponding to an initial speech estimate and a distribution value corresponding to an initial noise estimate. Each of the initial speech estimates are represented using absolute values of a difference between the observed spectrum and the corresponding noise spectrum. Each of the initial noise estimates is represented using absolute values corresponding to a difference between the observed spectrum and the corresponding speech spectrum. Subtracting the corresponding noise spectrum from the observed spectrum can include raising at least one of the noise spectrum and the observed spectrum to a power. Subtracting the corresponding speech spectrum from the observed signal can include raising at least one of the speech spectrum and the observed spectrum to a power. The weighted combination can be normalized by a sum of the subset of the plurality of scores, and the normalized weighted combination can be used in determining the clean speech estimate

Advantages of the foregoing techniques may include, but are not limited to, one or more of the following. Speech recognition performance can be improved by obtaining clean speech estimates in the presence of non-stationary noise while avoiding computationally intensive algorithms. Noise cancellation techniques for stationary noise can be used for obtaining the clean speech estimates in the presence complex non-stationary noise. Relatively low computational complexity of the algorithms used in the techniques described herein allows implementation on resource constrained platforms such as mobile device. This in turn allows for reduced latency and errors in the speech recognition process by avoiding communication with a remote speech recognition engine.

The systems and techniques described herein, or portions thereof, may be implemented as a computer program product that includes instructions that are stored on one or more non-transitory machine-readable storage media, and that are executable on one or more processing devices. The systems and techniques described herein, or portions thereof, may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a diagram of an example environment implementing a speech recognition system.

FIG. 2 is a conceptual block diagram illustrating an example of a clean speech estimation process.

FIG. 3 is a flowchart that shows an example of a sequence of operations for obtaining a clean speech estimate from an observed signal.

FIG. 4 is a plot showing constructive and destructive combinations of speech and noise signals.

FIG. 5 is a schematic representation of an exemplary mobile device that may implement embodiments of the speech recognition system described herein.

FIG. 6 is a block diagram illustrating the internal architecture of the device of FIG. 5.

FIG. 7 is a block diagram illustrating exemplary components of the operating system used by the device of FIG. 5.

FIG. 8 is a block diagram illustrating processes implemented by the operating system kernel of FIG. 7.

FIG. 9 shows an example of a computer device and a mobile computer device that can be used to implement the techniques described herein.

FIG. 10 is a graphical representation of experimental results.

Like reference symbols in the various drawings indicate like elements.

### DETAILED DESCRIPTION

Described herein are systems and processes for estimating clean speech from speech data observed in noisy environments. Effective speech recognition often involves determining clean speech estimates in the presence of complex (e.g. non-stationary) noise such as background music or conversations. Estimators that can estimate clean speech in the presence of non-stationary noise often use complex algorithms that are computationally intensive. In some cases, when a speech recognition system is implemented on a mobile device such as a smartphone or tablet computing device, such complex and computationally intensive noise cancellation processes may not be suitable. Described herein are methods and systems that allow estimating clean speech in the presence of non-stationary noise, yet use algorithms that are suitable for executing in a resource constrained environment such as a mobile device.

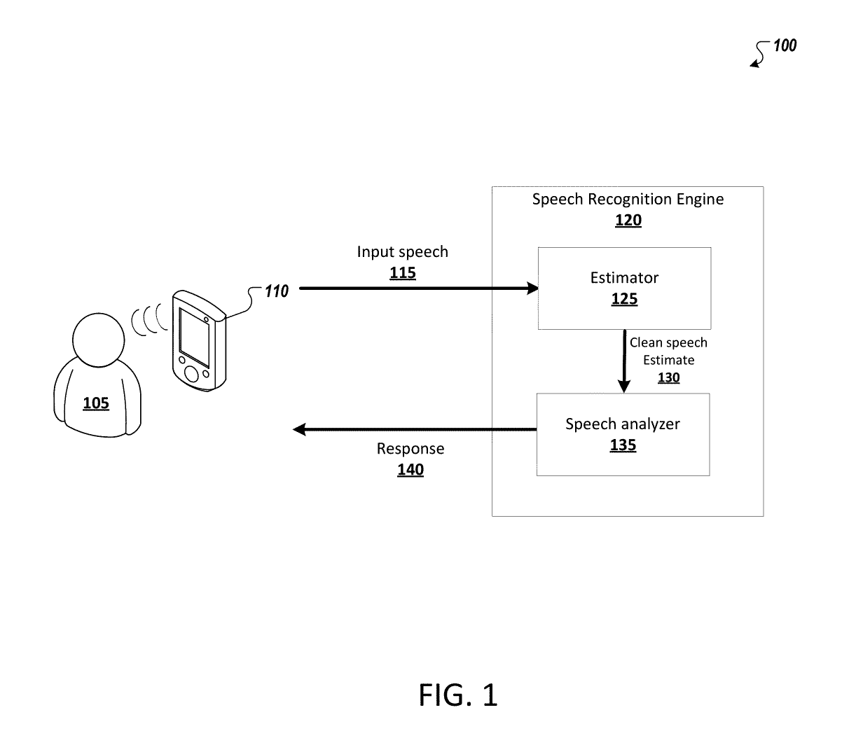

FIG. 1, describes an example environment 100 implementing a speech recognition system. The environment 100 includes a speech recognition engine 120 that operates on input speech 115 from a device 110 and provides a response 140 thereto. The input speech 115 can include spoken words from a user 105 of the device 110. The speech recognition engine 120 can include an estimator 125 that provides clean speech estimate 130 from the input speech 115. The clean speech estimate can be provided to a speech analyzer 135 to produce the response 140.

In some implementations, the device 110 can be a computing device, e.g., a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of two or more of these data processing devices or other appropriate data processing devices. In some implementations, a computing device may be included as part of a motor vehicle (e.g., an automobile, an emergency vehicle (e.g., fire truck, ambulance), a bus).

The input speech 115, which includes words or other sounds from the user 105 can also include noise. The noise can originate from the environment of the user 105. For example, the noise can include background sounds such as music, conversations, machinery noise, vehicle noise, noise due to wind or waves, or other sounds emanating from the environment of the user 105. The noise can be stationary, non-stationary, or a combination of stationary and non-stationary noise. In general, a random noise for which the corresponding probability distribution does not change with time, is referred to as stationary noise. In contrast, if a probability distribution corresponding to the noise varies as a function of time (or space), the noise is referred to as non-stationary noise. The probability distributions representing either type of noise can be one dimensional or multi-dimensional. In some implementations where the noise can be considered non-stationary, the noise may be modeled using mixture models such as a Gaussian mixture model. The noise can be additive (e.g. additive white Gaussian noise) or multiplicative noise.

The speech recognition engine 120 receives and processes the input speech 115. In some implementations, the speech recognition engine 120 can be implemented on a remote computing device such as a server. In such cases, the speech recognition engine 120 can receive the input speech 115 from the device 110 over a network such as a large computer network, examples of which include a local area network (LAN), wide area network (WAN), the Internet, a cellular network, or a combination thereof connecting a number of mobile computing devices, fixed computing devices, and server systems.

In some implementations, the speech recognition engine can be implemented on the device 110. Implementing the speech recognition engine 120 on the device 110 can have advantages that include, for example, reduced latency in the speech recognition process by avoiding communication with a remote speech recognition engine.

The speech recognition engine 120 can be implemented as any combination of software and hardware modules. For example, the speech recognition engine 120 can be implemented using a processor, memory and other hardware resources available on the device 110. In such cases, the input speech 115 can be received via a microphone or other sound capture hardware of the device 110. In some implementations, the speech recognition engine 120 can be implemented as a part of a voice controlled module such as in an automobile. Such voice control modules can be used to control different functions of the system in which the module is implemented. For example, using a voice control module in an automobile, a driver can control functionalities of one or more of a navigation system, a vehicle information system, an audio system, or a climate control system of the automobile.

In some implementations, the speech recognition engine includes an estimator 125 that produces clean speech estimate 130 from the input speech 115. The estimator 125 can be implemented using any combination of software and hardware modules. For example, the estimator 125 can be implemented using a processor executing software instructions for an algorithm that estimates the clean speech 130 from the input speech 115. The estimator 125 can be configured to provide the clean speech estimate 130 from the input speech 115 in the presence of stationary or non-stationary noise. Algorithms used by the estimator 125 to obtain the clean speech estimate 130 are described below in additional details.

In some implementations, the speech recognition engine 120 can also include a speech analyzer 135 that operates on the clean speech estimate 130 to provide the response 140. In some implementations, the speech analyzer 135 can be a speech to text converter that produces text output as the response 140 corresponding to the clean speech estimate 130. The speech analyzer 135 can also be a signal generator that generates as the response 140, a control signal based on analyzing the clean speech estimate. For example, the speech analyzer 135 can be configured to generate as the response 140, a control signal that initiates a phone call on the device 110 based on determining, from the clean speech estimate 130, that the user 105 provided such instructions through the input speech 115. In some implementations, the speech analyzer 135 can be configured to generate as the response 140, control signals for performing one or more of the operations including, for example, launching a browser, performing a search (e.g. a web search), launching an e-mail client, composing an e-mail, launching an application, or opening a file. For example, if the user 105 speaks to the device 110 to say “SEARCH FOR A NEARBY PIZZA PLACE,” the speech analyzer 135 can be configured to launch a browser or application and initiate a search for a pizza place using, for example, location information available from the device 110. In this example, the response 140 can be a webpage displaying the relevant search results. In another example, if the speech recognition engine 120 is implemented in an automobile and the user says “NAVIGATE TO HOME ADDRESS,” the speech analyzer 135 can be configured to generate a control signal that launches the navigation system of the automobile and calculates a route to a stored home address from the current location of the automobile.

In some implementations, the response 140 can include one or more of a control signal, text, audio, or a combination thereof. In some implementations, the response 140 can include audible speech. For example, the speech analyzer 135, in combination with a speech producing module can be configured to provide an audio response to the input speech 115 from the user. The speech producing module can include an artificial intelligence engine that determines what response 140 is provided for a particular input speech 115.

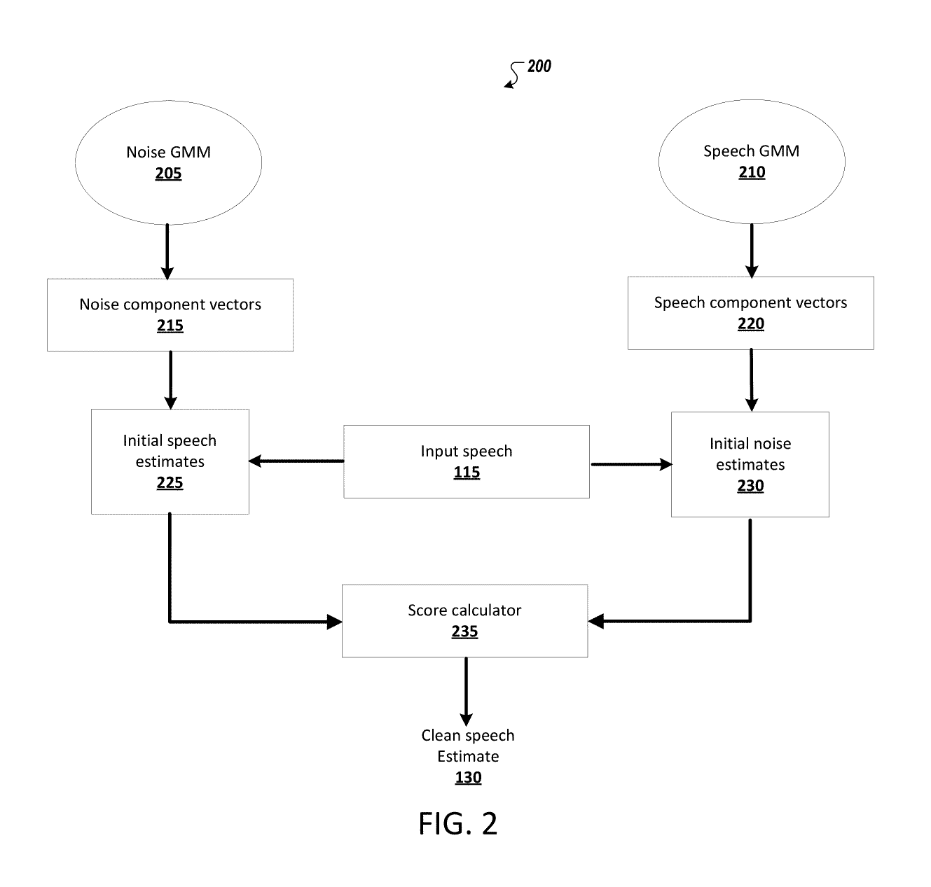

Referring to FIG. 2, a conceptual block diagram illustrating an example of a clean speech estimation process 200 is shown. In some implementations, at least portions of the process 200 represented in FIG. 2 is performed by the estimator 125 described above with reference to FIG. 1. The process described with reference to FIG. 2 can be used to estimate clean speech 130 in the presence of non-stationary noise that can corrupt the speech data in the input speech 115. The non-stationary noise can be modeled as a mixture model of a plurality of stationary noise distributions. Such modeling allows simple estimation methods such as spectral subtraction (that usually assumes the noise to be stationary) to be used for estimating clean speech in the presence of non-stationary noise. This approach avoids complex algorithms used in the presence of non-stationary noise and allows implementation on resource-constrained platforms such as mobile devices. The process 200 described with reference to FIG. 2 may be based on one or more mathematical frameworks described below.

In some implementations, in the presence of noise, a minimum mean squared error estimate of the clean speech can be given by the expected value:

E[x]=∫xp(x|y)dx (1)

wherein x denotes a random variable representing speech, y denotes a random variable representing noise, and E[.] denotes the expected value of a random variable. In some implementations, the integral to determine the clean speech (or the expected value of the random variable x) can be represented as summation of discrete points, which in turn can be further approximated as a weighted sum, which is given as:

$$E [ x ] \approx {\sum }_{s} {x}_{s} p ( {x}_{s} \vert y ) = {\sum }_{s} x ( s , y ) w ( s , y ) \qquad ( 2 )$$

wherein s denotes an index of the discrete points, the weights w(s, y) denote weights corresponding to the noise estimates at the discrete points xₛ and x(s, y) denotes an initial estimate of the speech variable x at the index points s, in the presence of the noise.

In some implementations, the point estimates x(s, y) can be determined using spectral subtraction. Spectral subtraction can be considered a technique for reducing additive noise from a signal. For example, consider that the speech signal x is corrupted by background noise n. This can be represented, for example, as:

y(m)=x(m)+n(m) (3)

where m designates the frequency bin. A frequency domain representation of the above can be computed by determining Fourier transform on both sides of equation (3). This is given as:

Y_{w}(e^{jω})=X_{w}(e^{jω})+N_{w}(e^{jω}) (4)

where Y(e^{jω}), X(e^{jω}), and N(e^{jω}) are Fourier transforms of windowed noisy, speech and noise signals respectively. Multiplying both sides by their complex conjugates yields:

|Y(e^{jω})|²=(e^{jω})²+|N(e^{jω})|²+²|X(e^{jω})λN(e^{jω})|cos(Δθ (5)

where Δθ is the phase difference between speech and noise. Assuming that the noise and speech magnitude spectrum values are independent of each other, and the phase of noise and speech are independent of each other and of their magnitude, the expected values on both sides yield:

$$\begin{matrix}E \{ {\vert Y ( {e}^{jω} ) \vert}^{2} \} = E \{ {\vert X ( {e}^{jω} ) \vert}^{2} \} + E \{ {\vert N ( {e}^{jω} ) \vert}^{2} \} + \\ E \{ 2 \vert X ( {e}^{jω} ) \vert \vert N ( {e}^{jω} ) \vert cos ( Δθ ) \} , \\ = E \{ {\vert X ( {e}^{jω} ) \vert}^{2} \} + E \{ {\vert N ( {e}^{jω} ) \vert}^{2} \} + \\ 2 E \{ \vert X ( {e}^{jω} ) \vert \} E \{ \vert N ( {e}^{jω} ) \vert \} E \{ cos ( Δθ ) \}\end{matrix} \qquad ( 6 )$$

In some implementations, a power spectral subtraction can be calculated based on equation (6). For power spectral subtraction, E{cos(Δθ)} is typically assumed to be equal to zero, thereby yielding:

|X(e^{jω})|²=|Y(e^{jω})|²−E{|N(e^{jω})|²} (7)

In some implementations, the power spectrum of noise can be estimated during speech inactive periods and subtracted from the power spectrum of the current frame to obtain the power spectrum of the speech.

In some implementations, a magnitude spectral subtraction can be calculated based on equation (6). For power spectral subtraction, E{cos(Δθ)} is typically assumed to be equal to unity, thereby yielding:

E{|Y(e^{jω})|}=E{|X(e^{jω})|}+E{|N(e^{jω})|} (8)

The magnitude spectrum of the noise can be averaged during speech inactive periods and the magnitude spectrum of speech can be estimated by subtracting the average spectrum of noise from the spectrum of the noisy speech.

A general assumption for spectral subtraction is that the noise can be considered stationary or at least relatively slowly varying. This condition allows for statistics of the noise to be updated during speech inactive periods. Spectral subtraction techniques are simple to implement and computationally inexpensive and therefore suitable for implementation on resource-constrained platforms such as mobile devices. However, the background noise encountered in speech recognition systems is often non-stationary. Music playing in the back ground and other people conversing in the background are examples of situations where the noise is non-stationary. Using spectral subtraction to estimate clean speech in such non-stationary noise environment can lead to inaccurate clean speech estimates. The methods and systems described herein allow for extension of spectral subtraction techniques to estimate clean speech in non-stationary noise environments. This in turn allows for implementation of a speech recognition engine in a resource constrained environment such as a mobile device.

In some implementations, spectral subtraction can be used to determine a set of initial estimates x(s, y) of the speech in the presence of noise to determine the clean speech estimate as a weighted sum of such initial estimates as given by equation (2). For this, the conditional distribution p(x|y) is computed from a speech model given by:

p(x|s)p(s); and

a noise model given by:

p(n|q)p(q).

In some implementations, Gaussian mixture models (GMM) can be used for the speech and noise models. A Gaussian Mixture Model (GMM) is a parametric probability density function represented as a weighted sum of Gaussian component densities. Each component density can be of one or more dimension. For example, the speech model described above can be represented as a GMM as:

$$p ( x \vert s ) p ( s ) = {\sum }_{s} {p}_{s} N ( x ; {μ}_{s} , {Σ}_{s} ) \qquad ( 9 )$$

where μₛ denotes a mean (if the density is one dimensional) or a mean vector (if the density is multi-dimensional) of the s th component density. Σₛ denotes a standard deviation (if the density is one dimensional) or a standard deviation vector (if the density is multi-dimensional) of the s th component density. Similarly, the noise model can be represented as a GMM as:

$$p ( n \vert q ) p ( q ) = {\sum }_{q} {p}_{q} N ( n ; {μ}_{q} , {Σ}_{q} ) \qquad ( 10 )$$

A GMM can be used as a parametric model of the probability distribution of continuous measurements or features in a speech recognition system. GMM parameters can be estimated from training data, for example, using the iterative Expectation-Maximization (EM) algorithm or from a prior model using, for example, Maximum A Posteriori (MAP) estimation.

In some implementations, obtaining an estimate of clean speech x from a noisy signal y is equivalent to computing the probability p(x|y). This can be done, for example, by defining a likelihood expression:

p(y|x,n)=(δ(y−(x+n)); and (11)

defining a join distribution as follows:

p(y_{obs},x,n,s,q)==p(y|x,n)p(x|s)p(s)p(n|q)p(q) (12)

where y_{obs} represents an observed signal that includes the speech and the noise. The conditional distribution p(x|y) can be computed by computing a marginal of the distribution given in equation (12) as:

$$p ( x \vert y ) = {\int \int }_{x , n} p ( y \vert x , n ) p ( x \vert s ) p ( s ) p ( n \vert q ) p ( q ) = {\int \int }_{x , n} p ( {y}_{obs} , x , n , s , q ) \qquad ( 13 )$$

In some implementations, the marginal on the right hand side of equation (13) can be approximated using point estimates of x and n as:

$${\int \int }_{x , n} p ( {y}_{obs} , x , n , s , q ) \approx p ( {y}_{obs} , {\hat{x}}_{q} , {\hat{n}}_{s} ) \qquad ( 14 )$$

where \hat{x}_{q}, \hat{n}ₛ are point estimates of x and n, respectively. In some implementations, the point estimates can be calculated using spectral subtraction. For example, a particular point estimate of x can be calculated as:

\hat{x}_{q}=y_{obs}−μ_{n,q} (15)

where μ_{n,q} is one of the noise component vectors (indexed by q) obtained, for example, from the GMM representing the noise. Each of the point estimates can be referred to as an initial estimate of the speech. The point estimates for n can also be calculated as:

\hat{n}ₛ=y_{obs}−μ_{x,s} (16)

where μ_{x,s} is one of the speech component vectors (indexed by s) obtained, for example, from the GMM representing the speech. From the point estimates calculated using equations (15) and (16), an approximation to the marginal on the right hand side of equation (13) can be computed as:

$${\int \int }_{x , n} p ( {y}_{obs} , x , n , s , q ) \approx p ( {y}_{obs} , {\hat{x}}_{q} , {\hat{n}}_{s} ) = {p}_{x} ( {\hat{x}}_{q} ) {p}_{n} ( {\hat{n}}_{s} ) \qquad ( 17 )$$

In some implementations, where a GMM is used to represent both the noise model and the speech model, equation (17) can be represented as:

P(y_{obs},\hat{x}_{q},\hat{n}ₛ)=pₓ(\hat{x}_{q})pₙ(\hat{n}ₛ)=N(\hat{x}_{q};μ_{x,s},Σ_{x,s})N(\hat{n}ₛ;μ_{n,q},Σ_{n,q}) (18)

In some implementations, where there are a plurality of point estimates for x (indexed by s) and a plurality of point estimates of n (indexed by q), equation (18) can be calculated for every combination of s and q. Each of these can be termed as a score for the particular combination of s and q, and denoted as:

score(q,s)=N(\hat{x}_{q};μ_{x,s},Σ_{x,s})N(\hat{n}ₛ;μ_{n,q},Σ_{n,q}) (19)

The clean speech estimate can be calculated from at least a subset of these scores. In some implementations, a Maximum A Posteriori (MAP) estimate or the maximum of the combinations is determined from the scores. In such cases the clean speech estimate \hat{x} is taken as the \hat{x}_{q} associated with the particular combination. In some implementations, the clean speech estimate is calculated as a minimum mean square error (MMSE) estimate based on the scores as:

$$\begin{matrix}\hat{x} = \frac{1}{C} {\sum }_{q} {\sum }_{s} {\hat{x}}_{q} \cdot score ( q , s ) & ( 20 ) \\ where C = {\sum }_{q} {\sum }_{s} score ( q , s ) & ( 21 )\end{matrix}$$

The parameter C can be referred to a normalizing factor for the weighted mean computed using equation (20).

Referring now to FIG. 2, the conceptual block diagram of the process 200 illustrates an example of computing a clean speech estimate using the mathematical framework described above. In this example the noise is modeled as a GMM 205, such as the GMM referred to in equation (10). In some implementations, the noise GMM 205 can be estimated substantially in real time, for example from a noise signal preceding or between the target speech signals. The noise GMM 205 can be estimated, for example, from a recording of a finite duration of background noise or other type of background content (e.g., music). The number of components in the noise GMM typically depends on the amount of detail and accuracy desired in the noise model. In general, the number of parameters related to the noise GMM 205 is a function of the number of components. For example, a ten component noise GMM 205 has ten mean vectors, ten covariance matrices and ten prior weights for the components.

The speech may also be modeled as a GMM 210, such as the GMM referred to in equation (9). The speech GMM 210 is usually a predetermined model computed from, for example, a database of different types of human speech. The speech GMM typically has more components than the noise GMM 205. For the present example, the speech GMM is assumed to have 200 components. Accordingly, the model will have 200 mean vectors, 200 covariance matrices and 200 prior weights associated with the model.

The parameters associated with the noise model can in general be referred to as noise component vectors 215. The noise components vectors can include, for example, the mean vectors μ_{n,q}, the covariance matrices and the prior weights associated with the noise model. In some implementations, if the component distributions of the mixture model representing the noise are univariate, the noise component vectors may have a single dimension. In some implementations, the noise component vectors are estimated from the noise GMM 205 using parameter estimation techniques such as maximum likelihood (ML) parameter estimation, maximum a-posteriori (MAP) parameter estimation, or k-nearest neighbor (KNN) parameter estimation. In the current example, 10 mean vectors for the noise are used as the noise component vectors 215. Additional parameters of the noise GMM 205 may also be considered as the noise component vectors 215. For example, the covariance matrices can also be used as the noise component vectors 215. In some implementations, the number of noise component vectors 215 considered in the clean speech estimation process is less than the number of components representing the noise GMM 205.

The parameters associated with the speech model can in general be referred to as speech component vectors 220. The speech components vectors can also include, for example, the mean vectors, the covariance matrices and the prior weights associated with the speech model. The speech component vectors have substantially similar properties as that of the noise component vectors 215. The number of speech component vectors 220 is usually higher than the number of noise component vectors 215 because a high accuracy of the speech modeling usually results in an accurate clean speech estimate 130. In the current example, 200 mean vectors obtained from the speech GMM 210 are used as the speech component vectors 220.

As described above with reference to FIG. 1, the input speech 115 includes one or more speech signals from a user and usually also includes noise. The methods and systems described herein are used to obtain the clean speech estimate 130 from the input speech 115. In some implementations, obtaining the input speech 115 includes dividing an incoming analog signal into segments of a predetermined time period and sampling the segments. In the current example, the incoming signal is segmented into 20 ms segments and sampled at 8 KHz to produce a discretized version of the incoming signal. A frequency domain transform can then be calculated using the discretized signal. For example, an N point fast Fourier transform (FFT) can be calculated to obtain an observation vector y_{obs} corresponding to a given segment. In some implementations, the vectors y_{obs} can be used to represent the input speech 115. Observation vectors for different segments can be denoted as a function of time. For example, in the current example where 20 ms segments are considered, an observation vector can be denoted as y_{obs}(t), which represents a segment at a (20 ms·t) offset from the beginning of the signal.

In some implementations, initial speech estimates 225 and initial noise estimates 230 are calculated from the input speech 115 using the noise component vectors 215 and speech component vectors 220, respectively. An initial speech estimate 225 is calculated for each noise component vector 215 using equation (15). In the current example, 10 initial speech estimates \hat{x}_{q} are determined, each corresponding to a different mean vector μ_{n,q}. Similarly, the initial noise estimates 230 are calculated using the input speech and the speech component vectors. In the current example, two hundred initial noise estimates 230 are determined using equation (16), each corresponding to a different mean vector μ_{x,x} obtained from the speech GMM 210.

In some implementations, the clean speech estimate 130 is obtained from the initial speech estimates 225 and the initial noise estimates 230 using a score calculator module 235. In some implementations, the score calculator computes a score for each of the different combinations of the noise component vectors 215 and the speech component vectors 220. In the current example, the ten noise component vectors and the two hundred speech component vectors yield two thousand different combinations and the score calculator module 235 calculates a score, for example using equation (19), for each of the two thousand combinations.

In some implementations, the score calculator module 235 can also be configured to choose an initial speech estimate 225 that corresponds to a particular score as the most likely candidate for the clean speech estimate. For example, the score calculator module 235 can be configured to determine a MAP estimate from the two thousand combinations and the initial speech estimate corresponding to that combination can be provided as the clean speech estimate 130. In some implementations, the clean speech estimate can be determined as an MMSE estimate from the various combinations, for example, using equations (20) and (21).

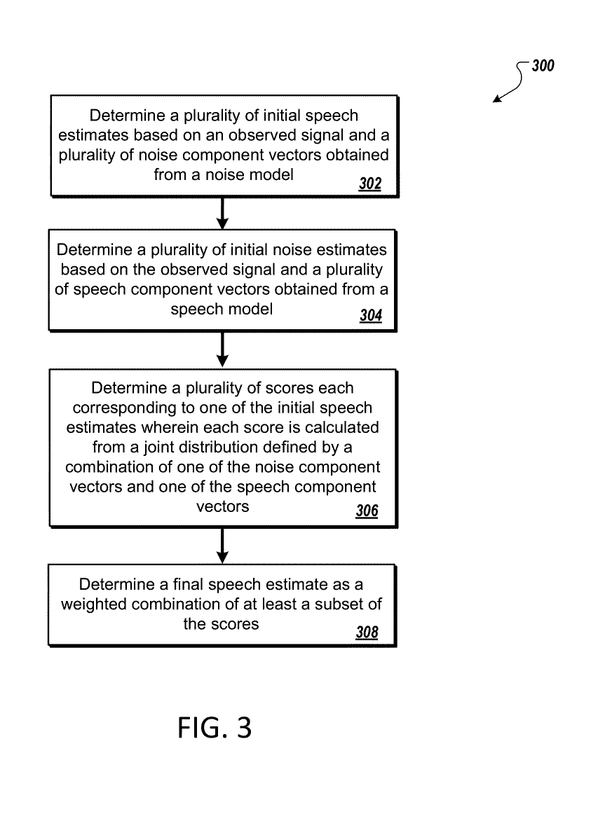

FIG. 3 is a flowchart 300 of an example sequence of operations for obtaining a clean speech estimate from an observed signal. One or more operations illustrated in the flowchart 300 can be performed at the estimator 125 described above with reference to FIG. 1. Operations can include determining a plurality of initial speech estimates based on an observed signal and a plurality of noise component vectors obtained from a noise model (302). The noise model can be a GMM. In some implementations, the initial speech estimates are substantially similar to the speech estimates 225 described with reference to FIG. 2 and are each determined by subtracting a noise spectrum from the spectrum of the observed signal. The noise spectrum can be represented by a corresponding noise component vector 215 as described with reference to FIG. 2.

Operations also include determining a plurality of initial noise estimates based on the observed signal and a plurality of speech component vectors obtained from a speech model (304). The speech model can be a GMM. In some implementations, the initial noise estimates are substantially similar to the noise estimates 230 described with reference to FIG. 2 and are each determined by subtracting a speech spectrum from the spectrum of the observed signal. The speech spectrum can be represented by a corresponding speech component vector 220 as described with reference to FIG. 2.

Operations can further include determining a plurality of scores each of which corresponds to one of the initial speech estimates and wherein each score is calculated from a joint distribution defined by a combination of one of the noise component vectors and one of the speech component vectors (306). In some implementations, the scores can be calculated using equation (19) described above.

Operations can also include determining a clean speech estimate as a weighted combination of at least a subset of the scores (308). In some implementations, all of the determined scores can be used in computing the final speech estimate. In some implementations, the weighted combination can be calculated using equations (20) and (21) described above.

Methods and systems that use spectral subtraction concepts typically assume a constructive combination of speech and noise signal as given by equation (3). However, in some cases, if the noise signal is larger than the speech signal, determining a point estimate of the speech using equation (15) can yield a negative estimate, which is unrealistic. In some implementations, additional processing can be incorporated to avoid determining negative estimates of the speech.

In some implementations, instead of using basic spectral subtraction (such as in equation (15)), a norm, for example a p-norm, can be used. Using a p-norm, a particular point estimate of the speech signal x can be calculated as:

\hat{x}_{q}=|y_{obs}^{p}−μ_{n,q}|^{1/p} (22)

The value of p can be determined, for example, experimentally. For example, a positive value between 0.5 and 2 can be used as the value of p. When p is equal to 1, equation (22) reduces to taking an absolute value of the difference.

In some implementations, a flooring strategy can also be used to avoid negative estimates. In such cases, a minimum threshold can be fixed and if the estimate is below the threshold, the threshold value is used as the estimate. For example, using the flooring strategy, the point estimates of the speech signal x can be calculated as:

\hat{x}_{q}=max(y_{obs}−μ_{n,q},|r·y_{obs}) (23)

The value of r can be chosen experimentally, for example, based on the application or the level of ambient noise. For example, the value of r can range from 0.05 to 0.5.

In some implementations, when calculating the clean speech estimate using equation (20), different methods can be used to calculate the score and the corresponding initial speech estimate. For example, equation (20) can be modified as follows:

$$\hat{x} = \frac{1}{C} {\sum }_{q} {\sum }_{s} {\hat{x}}_{q}^{′} \cdot score ( q , s ) \qquad ( 24 )$$

where the method to determine \hat{x}_{q} is different from the method to determine the \hat{x}_{q} used in calculating the score. For example, p-norm can be used for one and flooring can be used for the other. In another example, flooring can be used for both but with different values or r.

The mathematical framework described above allows for extending spectral subtraction to estimate speech in the presence of non-stationary noise which is modeled as a GMM of multiple stationary distributions. In some implementations, non-stationary noise and speech can be represented using temporal models with state sequences. For example, instead of using p(s) in the speech model, p(sₜ|sₜ₋₁) can be used. In some implementations, a Viterbi or Baum-Welch algorithm can be used to find the optimal state sequence as a part of finding the clean speech estimate 130.

As mentioned above, spectral subtraction concepts typically assume a constructive combination of speech and noise signal as given by equation (3). However, noise can also combine destructively with the speech signal. In such cases, the received signal is given by:

y(m)=x(m)−n(m) (25)

In some implementations, if the noise signal is larger than the speech signal, the destructive combination is given by:

y(m)=n(m)−x(m) (26)

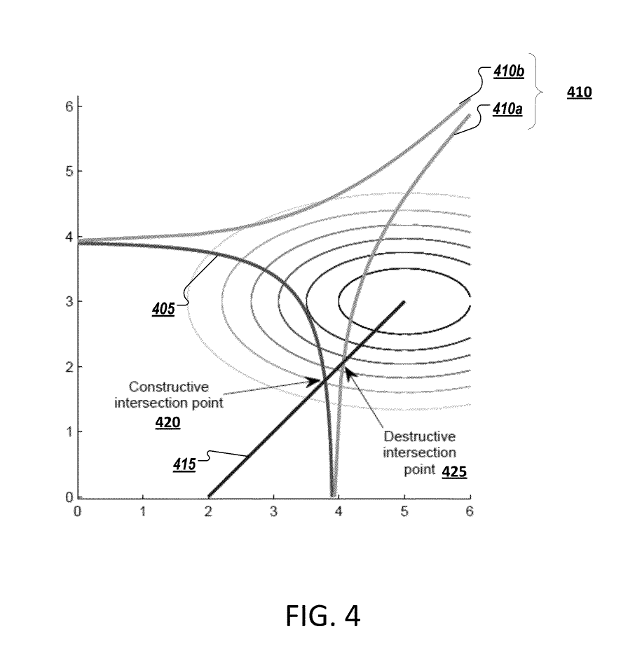

FIG. 4 shows a plot representing constructive and destructive combinations of speech and noise signals in a logarithmic domain. A trace 405 represents a constructive combination and traces 410a and 410b (410, in general) represents destructive combinations of the speech and noise. In case of constructive combinations, spectral subtraction can be seen as finding the intersection of the line n=μₙ with the constructive combination y=x+n. When y<μₙ, there is no solution and alternatives such as p-norms and flooring are used.

In some implementations, spectral subtraction can also be used to take into account intersections with the destructive combinations, by considering. the intersection of the line n=μₙ with y=x+n and y=x−n when y>μₙ and with y=x−n and y=n−x when y<μₙ. In some implementations, this is determined by considering a line 415 that passes through the point (μₓ, μₓ) and has the equation:

$$n = \frac{{μ}_{n}}{{μ}_{x}} x \qquad ( 27 )$$

where, μₙ and μₓ are mean energy level for the noise and the speech, respectively. The intersection of the line 415 with the constructive curve 405 is referred to as a constructive intersection point 420. The intersection of the line 415 with a destructive curve 410 is referred to as a destructive intersection point 425. In terms of the observed value y_{obs}, the constructive intersection point is given by:

$$( {x}_{con} , {n}_{con} ) = ( \frac{{y}_{obs}}{1 + {μ}_{x} / {μ}_{n}} , \frac{{y}_{obs}}{1 + {μ}_{n} / {μ}_{x}} ) \qquad ( 28 )$$

The destructive intersection point is given by:

$$( {x}_{des} , {n}_{des} ) = ( \frac{{y}_{obs}}{{μ}_{x} / {μ}_{n} - 1} , \frac{{y}_{obs}}{{μ}_{n} / {μ}_{x} - 1} ) \qquad ( 29 )$$

Given the multiple intersection points, one is chosen as a most likely intersection point or likely intersection points are combined in a weighted sum. Using prior models for both speech, the MMSE estimate for clean speech in this case is given by:

$$\begin{matrix}\hat{x} = E ( x ) \\ = \int x \cdot p ( {y}_{obs} , x , n ) d x d n \\ = \int p ( {y}_{obs} \vert x , n ) p ( x ) p ( n ) d x d n\end{matrix} \qquad ( 30 )$$

where p(x), with mode μₓ, is the speech prior model and p(n) with mode μₙ, is the noise prior model. In some implementations, instead of computing the full integral over x and n, a fast approximation can be calculated using only the intersection points as:

$$\hat{x} = E ( x ) \approx {\sum }_{p} Z \cdot {x}_{p} \cdot p ( {x}_{p} ) p ( {n}_{p} ) \qquad ( 31 )$$

where pε{con, des} and Z is a normalizing factor. In some implementations, log domain GMMs can be used to model the speech and the noise. In such a case, the estimate is given by:

$$\hat{x} = \frac{1}{2} {\sum }_{p} {\sum }_{s} {x}_{s , p} \cdot {π}_{{s}_{x}} N ( {x}_{s , p} , {μ}_{{s}_{x}} , {Σ}_{{s}_{x}} ) \cdot {π}_{{s}_{n}} N ( {n}_{s , p} , {μ}_{{s}_{n}} , {Σ}_{{s}_{n}} ) \qquad ( 32 )$$

where s={sₓ, sₙ} is the joint state index, π denotes the mixture priors, and N(•; μ, Σ) are multivariate Gaussian probability density functions. The values for x_{s,p} and x_{x,p} are the intersection points computed using equations (28) and (29).

Uncertainty decoding replaces the traditional likelihood for clean speech p(x|sₓ) with the likelihood for noisy speech p(y|sₓ) In some implementations, spectral Intersections can provide an approximation to the noisy speech likelihood for uncertainty decoding as:

$$p ( y \vert {s}_{x} ) ∝ {\sum }_{p} {\sum }_{{s}_{n}} {π}_{{s}_{x}} N ( {x}_{s , p} , {μ}_{{s}_{x}} , {Σ}_{{s}_{x}} ) \cdot {π}_{{s}_{n}} N ( {n}_{s , p} , {μ}_{{s}_{n}} , {Σ}_{{s}_{n}} ) . \qquad ( 33 )$$

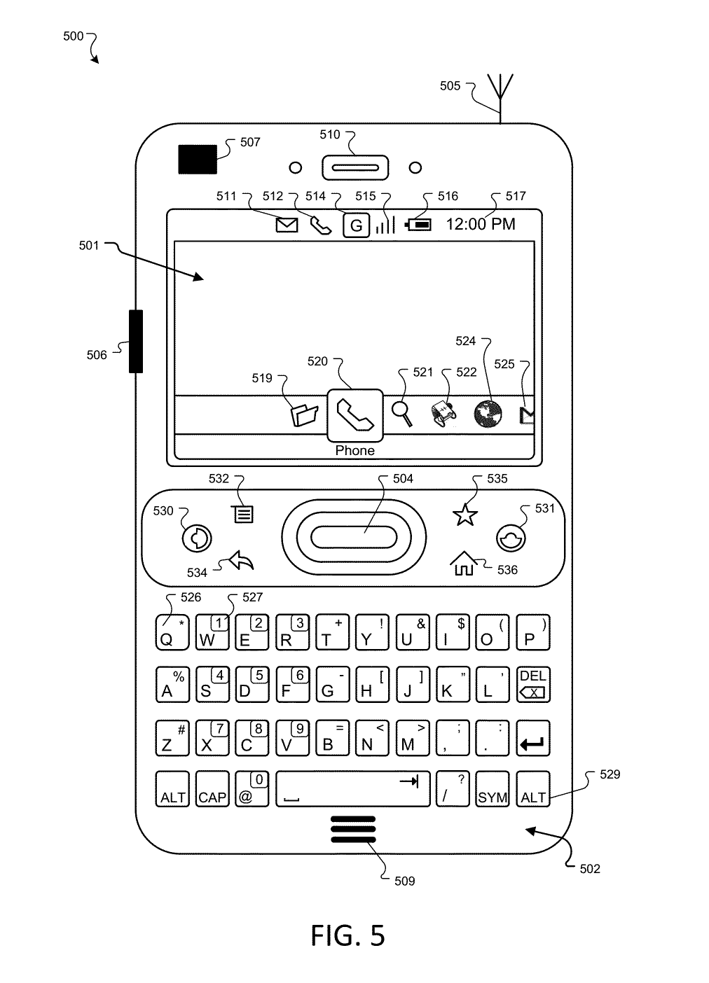

Referring now to FIG. 5, the exterior appearance of an exemplary device 500 that may be considered as a device (e.g., the device 110 shown in FIG. 1). Further the device 500 may implement the speech recognition engine 120 (shown in FIG. 1) or portions thereof (e.g., the estimator 125 or the speech analyzer 135). Briefly, and among other things, the device 500 includes a processor configured to convert speech to text upon request of a user of the mobile device.

In more detail, the hardware environment of the device 500 includes a display 501 for displaying text, images, and video to a user; a keyboard 502 for entering text data and user commands into the device 500; a pointing device 504 for pointing, selecting, and adjusting objects displayed on the display 501; an antenna 505; a network connection 506; a camera 507; a microphone 509; and a speaker 510. Although the device 500 shows an external antenna 505, the device 500 can include an internal antenna, which is not visible to the user.

The display 501 can display video, graphics, images, and text that make up the user interface for the software applications used by the device 500, and the operating system programs used to operate the device 500. Among the possible elements that may be displayed on the display 501 are a new mail indicator 511 that alerts a user to the presence of a new message; an active call indicator 512 that indicates that a telephone call is being received, placed, or is occurring; a data standard indicator 514 that indicates the data standard currently being used by the device 500 to transmit and receive data; a signal strength indicator 515 that indicates a measurement of the strength of a signal received by via the antenna 505, such as by using signal strength bars; a battery life indicator 516 that indicates a measurement of the remaining battery life; or a clock 517 that outputs the current time.

The display 501 may also show application icons representing various applications available to the user, such as a web browser application icon 519, a phone application icon 520, a search application icon 521, a contacts application icon 522, a mapping application icon 524, an email application icon 525, or other application icons. In one example implementation, the display 501 is a quarter video graphics array (QVGA) thin film transistor (TFT) liquid crystal display (LCD), capable of 16-bit or better color.

A user uses the keyboard (or “keypad”) 502 to enter commands and data to operate and control the operating system and applications that provide for speech recognition. The keyboard 502 includes standard keyboard buttons or keys associated with alphanumeric characters, such as keys 526 and 527 that are associated with the alphanumeric characters “Q” and “W” when selected alone, or are associated with the characters “*” and “1” when pressed in combination with key 529. A single key may also be associated with special characters or functions, including unlabeled functions, based upon the state of the operating system or applications invoked by the operating system. For example, when an application calls for the input of a numeric character, a selection of the key 527 alone may cause a “1” to be input.

In addition to keys traditionally associated with an alphanumeric keypad, the keyboard 502 also includes other special function keys, such as an establish call key 530 that causes a received call to be answered or a new call to be originated; a terminate call key 531 that causes the termination of an active call; a drop down menu key 532 that causes a menu to appear within the display 501; a backward navigation key 534 that causes a previously accessed network address to be accessed again; a favorites key 535 that causes an active web page to be placed in a bookmarks folder of favorite sites, or causes a bookmarks folder to appear; a home page key 536 that causes an application invoked on the device 500 to navigate to a predetermined network address; or other keys that provide for multiple-way navigation, application selection, and power and volume control.

The user uses the pointing device 504 to select and adjust graphics and text objects displayed on the display 501 as part of the interaction with and control of the device 500 and the applications invoked on the device 500. The pointing device 504 is any appropriate type of pointing device, and may be a joystick, a trackball, a touch-pad, a camera, a voice input device, a touch screen device implemented in combination with the display 501, or any other input device.

The antenna 505, which can be an external antenna or an internal antenna, is a directional or omni-directional antenna used for the transmission and reception of radiofrequency (RF) signals that implement point-to-point radio communication, wireless local area network (LAN) communication, or location determination. The antenna 505 may facilitate point-to-point radio communication using the Specialized Mobile Radio (SMR), cellular, or Personal Communication Service (PCS) frequency bands, and may implement the transmission of data using any number or data standards. For example, the antenna 305 may allow data to be transmitted between the device 500 and a base station using technologies such as Wireless Broadband (WiBro), Worldwide Interoperability for Microwave ACCess (WiMAX), 3GPP Long Term Evolution (LTE), Ultra Mobile Broadband (UMB), High Performance Radio Metropolitan Network (HIPERMAN), iBurst or High Capacity Spatial Division Multiple Access (HC-SDMA), High Speed OFDM Packet Access (HSOPA), High-Speed Packet Access (HSPA), HSPA Evolution, HSPA+, High Speed Upload Packet Access (HSUPA), High Speed Downlink Packet Access (HSDPA), Generic Access Network (GAN), Time Division-Synchronous Code Division Multiple Access (TD-SCDMA), Evolution-Data Optimized (or Evolution-Data Only) (EVDO), Time Division-Code Division Multiple Access (TD-CDMA), Freedom Of Mobile Multimedia Access (FOMA), Universal Mobile Telecommunications System (UMTS), Wideband Code Division Multiple Access (W-CDMA), Enhanced Data rates for GSM Evolution (EDGE), Enhanced GPRS (EGPRS), Code Division Multiple Access-2000 (CDMA2000), Wideband Integrated Dispatch Enhanced Network (WiDEN), High-Speed Circuit-Switched Data (HSCSD), General Packet Radio Service (GPRS), Personal Handy-Phone System (PHS), Circuit Switched Data (CSD), Personal Digital Cellular (PDC), CDMAone, Digital Advanced Mobile Phone System (D-AMPS), Integrated Digital Enhanced Network (IDEN), Global System for Mobile communications (GSM), DataTAC, Mobitex, Cellular Digital Packet Data (CDPD), Hicap, Advanced Mobile Phone System (AMPS), Nordic Mobile Phone (NMP), Autoradiopuhelin (ARP), Autotel or Public Automated Land Mobile (PALM), Mobiltelefonisystem D (MTD), Offentlig Landmobil Telefoni (OLT), Advanced Mobile Telephone System (AMTS), Improved Mobile Telephone Service (IMTS), Mobile Telephone System (MTS), Push-To-Talk (PTT), or other technologies. Communication via W-CDMA, HSUPA, GSM, GPRS, and EDGE networks may occur, for example, using a QUALCOMM MSM7200A chipset with a QUALCOMM RTR6285™ transceiver and PM7540™ power management circuit.

The wireless or wired computer network connection 506 may be a modem connection, a local-area network (LAN) connection including the Ethernet, or a broadband wide-area network (WAN) connection such as a digital subscriber line (DSL), cable high-speed internet connection, dial-up connection, T-1 line, T-3 line, fiber optic connection, or satellite connection. The network connection 506 may connect to a LAN network, a corporate or government WAN network, the Internet, a telephone network, or other network. The network connection 506 uses a wired or wireless connector. Example wireless connectors include, for example, an INFRARED DATA ASSOCIATION (IrDA) wireless connector, a Wi-Fi wireless connector, an optical wireless connector, an INSTITUTE OF ELECTRICAL AND ELECTRONICS ENGINEERS (IEEE) Standard 802.11 wireless connector, a BLUETOOTH wireless connector (such as a BLUETOOTH version 1.2 or 3.0 connector), a near field communications (NFC) connector, an orthogonal frequency division multiplexing (OFDM) ultra wide band (UWB) wireless connector, a time-modulated ultra wide band (TM-UWB) wireless connector, or other wireless connector. Example wired connectors include, for example, an IEEE-1394 FIREWIRE connector, a Universal Serial Bus (USB) connector (including a mini-B USB interface connector), a serial port connector, a parallel port connector, or other wired connector. In another implementation, the functions of the network connection 506 and the antenna 505 are integrated into a single component.

The camera 507 allows the device 500 to capture digital images, and may be a scanner, a digital still camera, a digital video camera, or another digital input device. In one example implementation, the camera 507 is a 3 mega-pixel (MP) camera that utilizes a complementary metal-oxide semiconductor (CMOS).

The microphone 509 allows the device 500 to capture sound, and may be an omni-directional microphone, a unidirectional microphone, a bi-directional microphone, a shotgun microphone, or other type of apparatus that converts sound to an electrical signal. The microphone 509 may be used to capture sound generated by a user, for example when the user is speaking to another user during a telephone call via the device 500. Conversely, the speaker 510 allows the device to convert an electrical signal into sound, such as a voice from another user generated by a telephone application program, or a ring tone generated from a ring tone application program. Furthermore, although the device 500 is illustrated in FIG. 3 as a handheld device, in further implementations the device 500 may be a laptop, a workstation, a midrange computer, a mainframe, an embedded system, telephone, desktop PC, a tablet computer, a PDA, or other type of computing device.

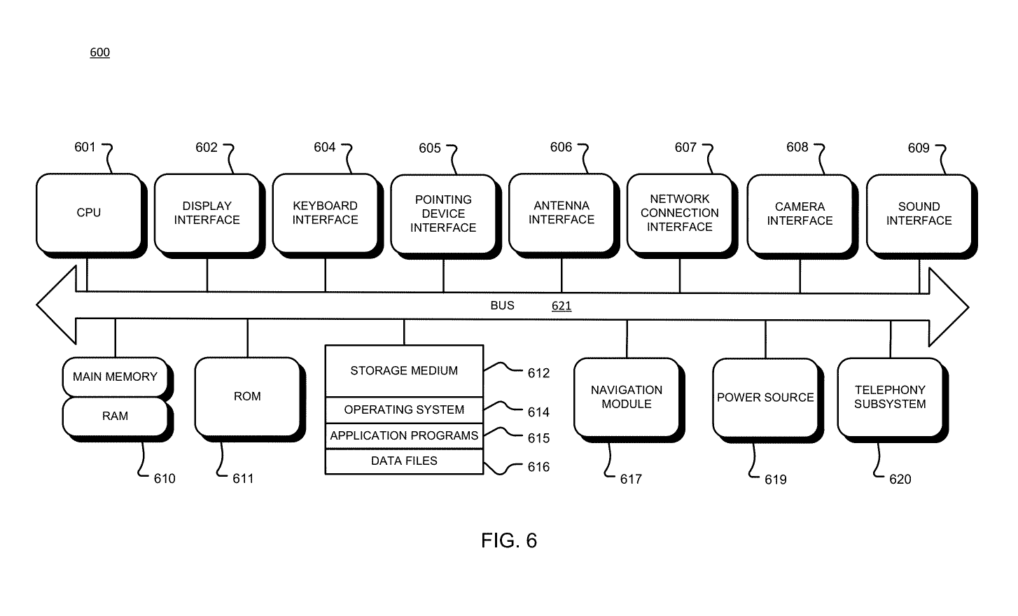

FIG. 6 is a block diagram illustrating an internal architecture 600 of the device 500. The architecture includes a central processing unit (CPU) 601 where the computer instructions that comprise an operating system or an application are processed; a display interface 602 that provides a communication interface and processing functions for rendering video, graphics, images, and texts on the display 501, provides a set of built-in controls (such as buttons, text and lists), and supports diverse screen sizes; a keyboard interface 604 that provides a communication interface to the keyboard 502; a pointing device interface 605 that provides a communication interface to the pointing device 504; an antenna interface 606 that provides a communication interface to the antenna 505; a network connection interface that provides a communication interface to a network over the computer network connection 506; a camera interface 608 that provides a communication interface and processing functions for capturing digital images from the camera 507; a sound interface 609 that provides a communication interface for converting sound into electrical signals using the microphone 509 and for converting electrical signals into sound using the speaker 510; a random access memory (RAM) 610 where computer instructions and data are stored in a volatile memory device for processing by the CPU 601; a read-only memory (ROM) 611 where invariant low-level systems code or data for basic system functions such as basic input and output (I/O), startup, or reception of keystrokes from the keyboard 502 are stored in a non-volatile memory device; a storage medium 612 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files that comprise an operating system 614, application programs 615 (including, for example, a web browser application, a widget or gadget engine, and or other applications, as necessary) and data files 616 are stored; a navigation module 617 that provides a real-world or relative position or geographic location of the device 500; a power source 619 that provides an appropriate alternating current (AC) or direct current (DC) to power components; and a telephony subsystem 620 that allows the device 500 to transmit and receive sound over a telephone network. The constituent devices and the CPU 601 communicate with each other over a bus 621.

The CPU 601 can be one of a number of computer processors. In one arrangement, the computer CPU 601 is more than one processing unit. The RAM 610 interfaces with the computer bus 621 so as to provide quick RAM storage to the CPU 601 during the execution of software programs such as the operating system application programs, and device drivers. More specifically, the CPU 601 loads computer-executable process steps from the storage medium 612 or other media into a field of the RAM 610 in order to execute software programs. Data is stored in the RAM 610, where the data is accessed by the computer CPU 601 during execution. In one example configuration, the device 500 includes at least 128 MB of RAM, and 256 MB of flash memory.

The storage medium 612 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 500 to access computer-executable process steps, application programs and the like, stored on removable and non-removable memory media, to off-load data from the device 500, or to upload data onto the device 500.

A computer program product is tangibly embodied in storage medium 612, a machine-readable storage medium. The computer program product includes instructions that, when read by a machine, operate to cause a data processing apparatus to store data in the mobile device. In some embodiments, the computer program product includes instructions that managing acoustic models.

The operating system 614 may be a LINUX-based operating system such as the GOOGLE mobile device platform; APPLE MAC OS X; MICROSOFT WINDOWS NT/WINDOWS 2000/WINDOWS XP/WINDOWS MOBILE; a variety of UNIX-flavored operating systems; or a proprietary operating system for computers or embedded systems. The application development platform or framework for the operating system 614 may be: BINARY RUNTIME ENVIRONMENT FOR WIRELESS (BREW); JAVA Platform, Micro Edition (JAVA ME) or JAVA 2 Platform, Micro Edition (J2ME) using the SUN MICROSYSTEMS JAVASCRIPT programming language; PYTHON™, FLASH LITE, or MICROSOFT .NET Compact, or another appropriate environment.

The device stores computer-executable code for the operating system 614, and the application programs 615 such as an email, instant messaging, a video service application, a mapping application word processing, spreadsheet, presentation, gaming, mapping, web browsing, JAVASCRIPT engine, or other applications. For example, one implementation may allow a user to access an email application, an instant messaging application, a video service application, a mapping application, or an imaging editing and presentation application. The application programs 615 may also include a widget or gadget engine, such as a TAFRI™ widget engine, a MICROSOFT gadget engine such as the WINDOWS SIDEBAR gadget engine or the KAPSULES™ gadget engine, a YAHOO! widget engine such as the KONFABULTOR™ widget engine, the APPLE DASHBOARD widget engine, a gadget engine, the KLIPFOLIO widget engine, an OPERA™ widget engine, the WIDSETS™ widget engine, a proprietary widget or gadget engine, or other widget or gadget engine the provides host system software for a physically-inspired applet on a desktop.

Although it is possible to provide for acoustic model management using the above-described implementation, it is also possible to implement the functions according to the present disclosure as a dynamic link library (DLL), or as a plug-in to other application programs such as an Internet web-browser such as the FOXFIRE web browser, the APPLE SAFARI web browser or the MICROSOFT INTERNET EXPLORER web browser.

The navigation module 617 may determine an absolute or relative position of the device, such as by using the Global Positioning System (GPS) signals, the GLObal NAvigation Satellite System (GLONASS), the Galileo positioning system, the Beidou Satellite Navigation and Positioning System, an inertial navigation system, a dead reckoning system, or by accessing address, internet protocol (IP) address, or location information in a database. The navigation module 617 may also be used to measure angular displacement, orientation, or velocity of the device 500, such as by using one or more accelerometers.

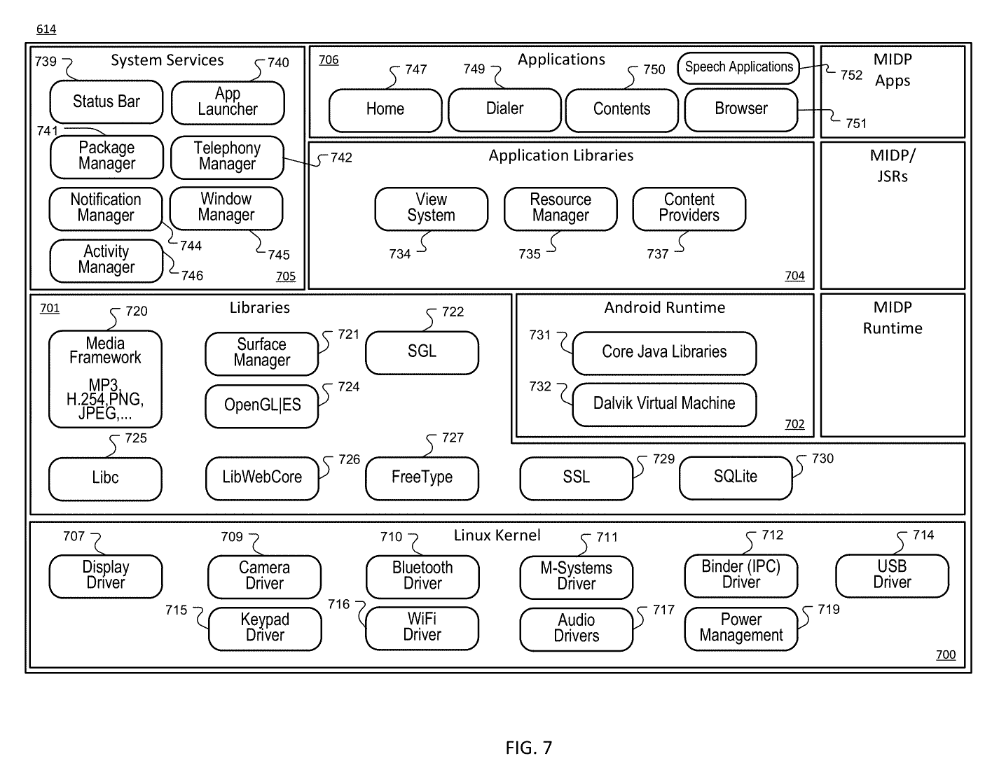

FIG. 7 is a block diagram illustrating exemplary components of the operating system 614 used by the device 500, in the case where the operating system 614 is the GOOGLE mobile device platform. The operating system 614 invokes multiple processes, while ensuring that the associated phone application is responsive, and that wayward applications do not cause a fault (or “crash”) of the operating system. Using task switching, the operating system 614 allows for the switching of applications while on a telephone call, without losing the state of each associated application. The operating system 614 may use an application framework to encourage reuse of components, and provide a scalable user experience by combining pointing device and keyboard inputs and by allowing for pivoting. Thus, the operating system can provide a rich graphics system and media experience, while using an advanced, standards-based web browser.

The operating system 614 can generally be organized into six components: a kernel 700, libraries 701, an operating system runtime 702, application libraries 704, system services 705, and applications 706. The kernel 700 includes a display driver 707 that allows software such as the operating system 614 and the application programs 615 to interact with the display 501 via the display interface 602, a camera driver 709 that allows the software to interact with the camera 507; a BLUETOOTH driver 710; a M-Systems driver 711; a binder (IPC) driver 712, a USB driver 714 a keypad driver 715 that allows the software to interact with the keyboard 502 via the keyboard interface 604; a WiFi driver 716; audio drivers 717 that allow the software to interact with the microphone 509 and the speaker 510 via the sound interface 609; and a power management component 719 that allows the software to interact with and manage the power source 619.

The BLUETOOTH driver, which in one implementation is based on the BlueZ BLUETOOTH stack for LINUX-based operating systems, provides profile support for headsets and hands-free devices, dial-up networking, personal area networking (PAN), or audio streaming (such as by Advance Audio Distribution Profile (A2DP) or Audio/Video Remote Control Profile (AVRCP). The BLUETOOTH driver provides JAVA bindings for scanning, pairing and unpairing, and service queries.

The libraries 701 include a media framework 720 that supports standard video, audio and still-frame formats (such as Moving Picture Experts Group (MPEG)-4, H.264, MPEG-1 Audio Layer-3 (MP3), Advanced Audio Coding (AAC), Adaptive Multi-Rate (AMR), Joint Photographic Experts Group (JPEG), and others) using an efficient JAVA Application Programming Interface (API) layer; a surface manager 721; a simple graphics library (SGL) 722 for two-dimensional application drawing; an Open Graphics Library for Embedded Systems (OpenGL ES) 724 for gaming and three-dimensional rendering; a C standard library (LIBC) 725; a LIBWEBCORE library 726; a FreeType library 727; an SSL 729; and an SQLite library 730.

The operating system runtime 702 includes core JAVA libraries 731, and a Dalvik virtual machine 732. The Dalvik virtual machine 732 is a custom, virtual machine that runs a customized file format (.DEX).

The operating system 614 can also include Mobile Information Device Profile (MIDP) components such as the MIDP JAVA Specification Requests (JSRs) components, MIDP runtime, and MIDP applications. The MIDP components can support MIDP applications running on the device 500.

With regard to graphics rendering, a system-wide composer manages surfaces and a frame buffer and handles window transitions, using the OpenGL ES 724 and two-dimensional hardware accelerators for its compositions.

The Dalvik virtual machine 732 may be used with an embedded environment, since it uses runtime memory very efficiently, implements a CPU-optimized bytecode interpreter, and supports multiple virtual machine processes per device. The custom file format (.DEX) is designed for runtime efficiency, using a shared constant pool to reduce memory, read-only structures to improve cross-process sharing, concise, and fixed-width instructions to reduce parse time, thereby allowing installed applications to be translated into the custom file formal at build-time. The associated bytecodes are designed for quick interpretation, since register-based instead of stack-based instructions reduce memory and dispatch overhead, since using fixed width instructions simplifies parsing, and since the 16-bit code units minimize reads.

The application libraries 704 include a view system 734, a resource manager 735, and content providers 737. The system services 705 includes a status bar 739; an application launcher 740; a package manager 741 that maintains information for all installed applications; a telephony manager 742 that provides an application level JAVA interface to the telephony subsystem 620; a notification manager 744 that allows all applications access to the status bar and on-screen notifications; a window manager 745 that allows multiple applications with multiple windows to share the display 501; and an activity manager 746 that runs each application in a separate process, manages an application life cycle, and maintains a cross-application history.

The applications 706 include a home application 747, a dialer application 749, a contacts application 750, a browser application 751, and speech applications 752, which can include, for example, one or more of the speech recognition engine 120, the estimator 125, and the speech analyzer 135 described above with reference to FIG. 1. In some implementations, the speech applications 752 can reside outside the applications portion 706 of the operating system 614.

The telephony manager 742 provides event notifications (such as phone state, network state, Subscriber Identity Module (SIM) status, or voicemail status), allows access to state information (such as network information, SIM information, or voicemail presence), initiates calls, and queries and controls the call state. The browser application 751 renders web pages in a full, desktop-like manager, including navigation functions. Furthermore, the browser application 751 allows single column, small screen rendering, and provides for the embedding of HTML views into other applications.

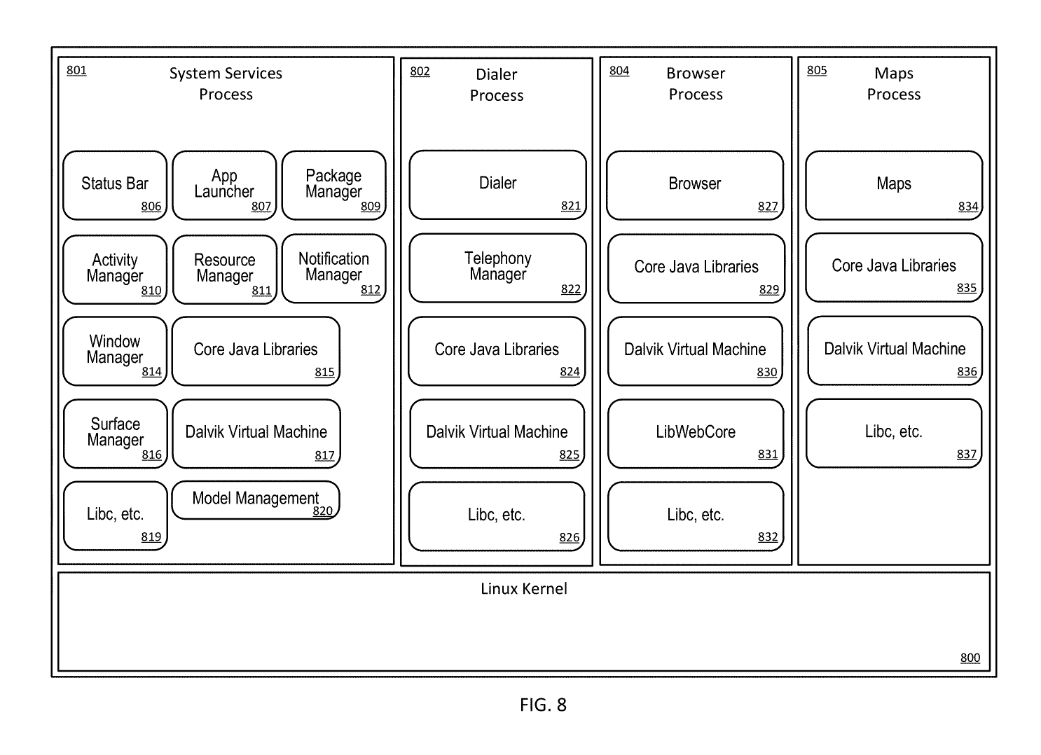

FIG. 8 is a block diagram illustrating exemplary processes implemented by the operating system kernel 800. Generally, applications and system services run in separate processes, where the activity manager 746 runs each application in a separate process and manage the application life cycle. The applications run in their own processes, although many activities or services can also run in the same process. Processes are started and stopped as needed to run an application's components, and processes may be terminated to reclaim resources. Each application is assigned its own process, whose name is the application's package name, and individual parts of an application can be assigned another process name.

Some processes can be persistent. For example, processes associated with core system components such as the surface manager 816, the window manager 814, or the activity manager 810 can be continuously executed while the device 500 is powered. Additionally, some application-specific process can also be persistent. For example, processes associated with the dialer application 821, may also be persistent.

The processes implemented by the operating system kernel 800 may generally be categorized as system services processes 801, dialer processes 802, browser processes 804, and maps processes 805. The system services processes 801 include status bar processes 806 associated with the status bar 739; application launcher processes 807 associated with the application launcher 740; package manager processes 809 associated with the package manager 741; activity manager processes 810 associated with the activity manager 746; resource manager processes 811 associated with a resource manager 811 that provides access to graphics, localized strings, and XML layout descriptions; notification manger processes 812 associated with the notification manager 744; window manager processes 814 associated with the window manager 745; core JAVA libraries processes 815 associated with the core JAVA libraries 731; surface manager processes 816 associated with the surface manager 721; Dalvik virtual machine processes 817 associated with the Dalvik virtual machine 732, LIBC processes 819 associated with the LIBC library 725; and model management processes 820.

The dialer processes 802 include dialer application processes 821 associated with the dialer application 749; telephony manager processes 822 associated with the telephony manager 742; core JAVA libraries processes 824 associated with the core JAVA libraries 731; Dalvik virtual machine processes 825 associated with the Dalvik Virtual machine 732; and LIBC processes 826 associated with the LIBC library 725. The browser processes 804 include browser application processes 827 associated with the browser application 751; core JAVA libraries processes 829 associated with the core JAVA libraries 731; Dalvik virtual machine processes 830 associated with the Dalvik virtual machine 732; LIBWEBCORE processes 831 associated with the LIBWEBCORE library 726; and LIBC processes 832 associated with the LIBC library 725.

The maps processes 805 include maps application processes 834, core JAVA libraries processes 835, Dalvik virtual machine processes 836, and LIBC processes 837. Notably, some processes, such as the Dalvik virtual machine processes, may exist within one or more of the systems service processes 801, the dialer processes 802, the browser processes 804, and the maps processes 805.

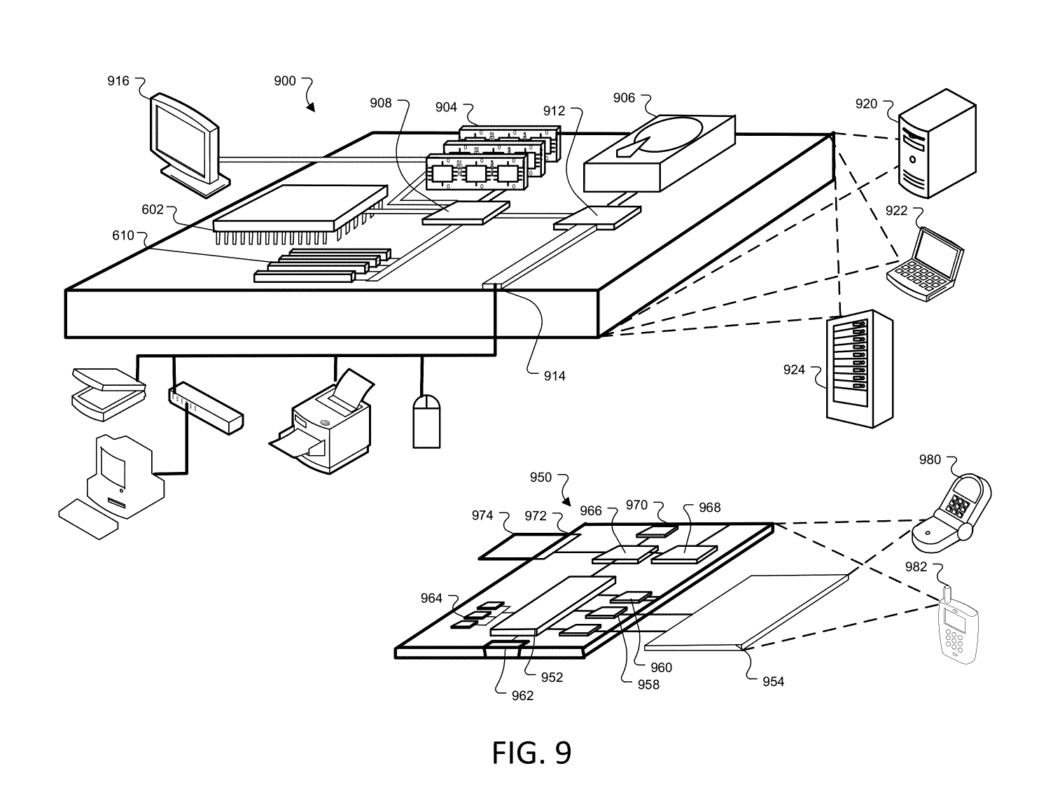

FIG. 9 shows examples of computing devices on which the processes described herein, or portions thereof, may be implemented. In this regard, FIG. 9 shows an example of a generic computing device 900 and a generic mobile computing device 950, which may be used to implement the processes described herein, or portions thereof. For example, model manager 208 (shown in FIG. 2) may be implemented on computing device 900. Mobile computing device 950 may represent a client device 110 of FIG. 1. Other client devices of FIG. 1 may also have the architecture of computing device 900 or mobile computing device 950.

Computing device 900 is intended to represent various forms of digital computers, examples of which include laptops, desktops, workstations, personal digital assistants, servers, blade servers, mainframes, and other appropriate computers. Computing device 950 is intended to represent various forms of mobile devices, examples of which include personal digital assistants, cellular telephones, smartphones, and other similar computing devices. The components shown here, their connections and relationships, and their functions, are meant to be exemplary only, and are not meant to limit implementations of the implementations described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Components 902, 904, 906, 908, 910, and 912, are interconnected using various busses, and may be mounted on a common motherboard or in other manners as appropriate. The processor 902 may process instructions for execution within the computing device 900, including instructions stored in the memory 904 or on the storage device 906 to display graphical information for a GUI on an external input/output device, for example, display 916 coupled to high speed interface 908. In other implementations, multiple processors and/or multiple buses may be used, as appropriate, along with multiple memories and types of memory. Also, multiple computing devices 900 may be connected, with a device providing a portion of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, examples of which include a magnetic or optical disk.

The storage device 906 is capable of providing mass storage for the computing device 900. In one implementation, the storage device 906 may be or contain a computer-readable medium, examples of which include a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, including those described above. The information carrier may be a non-transitory computer- or machine-readable medium, for example, the memory 904, the storage device 906, or memory on processor 902. For example, the information carrier may be a non-transitory, machine-readable storage medium.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, e.g., a keyboard, a pointing device, a scanner, or a networking device, e.g., a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer, e.g., a laptop computer 922. Alternatively, components from computing device 900 may be combined with other components in a mobile device (not shown), e.g., device 950. Such devices may contain one or more of computing device 900, 950, and an entire system may be made up of multiple computing devices 900, 950 communicating with one other.

Computing device 950 includes a processor 952, memory 964, an input/output device, e.g. a display 954, a communication interface 966, and a transceiver 968, among other components. The device 950 may also be provided with a storage device, e.g., a microdrive or other device, to provide additional storage. The components 950, 952, 964, 954, 966, and 968, are interconnected using various buses, and several of the components may be mounted on a common motherboard or in other manners as appropriate.

The processor 952 may execute instructions within the computing device 950, including instructions stored in the memory 964. The processor may be implemented as a chipset of chips that include separate and multiple analog and digital processors. The processor may provide, for example, for coordination of the other components of the device 950, e.g., control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may include appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 may be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided by the SIMM cards, along with additional information, e.g., placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, including those described above. The information carrier is a computer- or machine-readable medium, e.g., the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, examples of which include GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, e.g., using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, e.g., through a speaker, e.g., in a handset of device 950. Such sound may include sound from voice telephone calls, may include recorded sound (e.g., voice electronic messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

### Experimental Results

The following describes the results of particular experiments, which do not limit the scope provided by the claims of this disclosure.

The algorithms described herein were tested on real utterances from the Google Voice Search system. Since the utterances were generally near field and of high SNR, background music was artificially added to the data to produce noise conditions with varying SNR.

The dataset consisted of approximately 38,000 manually transcribed utterances containing thirty-eight hours of English language spoken queries to Google Voice Search. The utterances were spoken by 296 different speakers, and ranged in length from 0.2 to 12.3 seconds, with a mean of 3.6 seconds. The utterances were recorded and stored in 16-bit, 16 kHz uncompressed format.

The dataset contained a varying amount of speech for each speaker and hence the amount of training data for each speech model was different. To train the speech model for each speaker, the data was segmented into a low-noise training data, and higher noise-test data. A 257-dimensional log-spectral feature vectors for each of the speaker's utterances were computed using 25 ms frames spaced every 10 ms. Most of the cleaner speech data contained low non-stationary background noise, such as TV noise. If speech models are trained directly on this data, the majority of the model components are allocated to modeling this low non-stationary noise background. To circumvent this problem, a percentile based VAD was used to separate the low-noise condition speech into speech frames and non-speech frames. From the speech frames, a GMM with at most two hundred components was estimated subject to the constraint that there were at least 15 frames per Gaussian component. From the non-speech frames a smaller twenty-component GMM was estimated. These two models were then combined to form a clean-speech GMM.

At least 30% of the data for each speaker was held out as test data. For each utterance in the test set, a random song from a database of 500 popular songs was selected, and mixed with the utterance at the desired SNR. Noise models were trained on the music directly prior to the speech. To facilitate this, 8 seconds of musical prologue was included before the onset of speech in the utterance. The same 257-dimensional log-spectral feature vectors were used to create the speech model, and the feature frames from the prologue were used to construct 8 mixture noise GMMs.

The SNR of the utterances for each speaker was first computed. Based on the SNR, they were divided into training and testing sets, where the least-noisy 70% of the data was used for training and the remaining 30% was used for testing.

The Max and Algonquin algorithms and Spectral Intersections were used as noise reduction techniques using the per-speaker speech model constructed from the speaker's training data, and the per-utterance noise model was constructed from each utterance's prologue.

The resulting cleaned feature frame sequence \was then resynthesized as a waveform using the overlap-add algorithm and sent to the speech recognizer to test the denoising quality. All speech recognition was performed with a recent version of Google's Voice Search speech recognizer. This system uses an acoustic model with approximately 8000 context-dependent states and approximately 330 k Gaussians, and is trained with LDA, STC, and MMI. The Voice Search language model used for recognition contains more than one million English words.

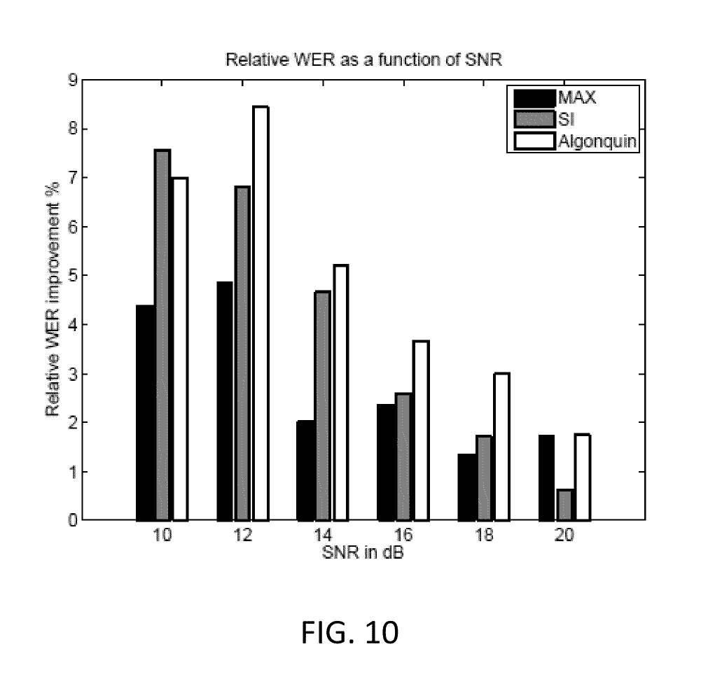

The acoustic models were not retrained. However, the relative performance of the respective methods was expected to remain the same. The results are shown in FIG. 10 and summarized in Table 1. As can be seen from Table 1 and FIG. 10, the spectral intersection method follows the trend of Algonquin but provides slightly less gain in all conditions except the nosiest 10 dB condition. However, the performance of the spectral intersection method exceeds that of Max in almost all conditions.

TABLE 1
Average reduction in Word Error Rate (WER) for noise levels between
10-20 dB

| | MAX | SI | Algon. |
|---|---|---|---|
| Average WER reduction | 2.7 | 4.0 | 4.8 |
| WER reduction at 10 dB | 4.6 | 7.6 | 7.0 |

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to a signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be a form of sensory feedback (e.g., visual feedback, auditory feedback, or tactile feedback); and input from the user may be received in a form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or a combination of such back end, middleware, or front end components. The components of the system may be interconnected by a form or medium of digital data communication (e.g., a communication network). Examples of communication networks include a local area network (“LAN”), a wide area network (“WAN”), and the Internet.

The computing system may include clients and servers. A client and server are generally remote from one other and typically interact through a communication network. The relationship of client and server arises by virtue of computer programs running on the respective computers and having a client-server relationship to one other.

In some implementations, the engines described herein may be separated, combined or incorporated into a single or combined engine. The engines depicted in the figures are not intended to limit the systems described here to the software architectures shown in the figures.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information may be determined for the user, or a user's geographic location may be generalized where location information is obtained (e.g., to a city, zip code, or state level), so that a particular location of the user cannot be determined.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

The features described herein may be combined in a single system, or used separately in one or more systems.

Other implementations not specifically described herein are also within the scope of the following claims.

What is claimed is:

1. A method for estimating speech signal in presence of non-stationary noise, the method comprising:
receiving, at a speech recognition engine, an input speech signal comprising non-stationary noise;
determining a plurality of initial speech estimates by subtracting a plurality of noise spectra, respectively, from a spectrum of the input speech signal, wherein each of the noise spectra is represented by a noise component vector obtained from a Gaussian mixture model representing the non-stationary noise;
determining a plurality of initial noise estimates for the non-stationary noise by subtracting a plurality of speech spectra, respectively, from the spectrum of the input speech signal, wherein each of the speech spectra is represented by a speech component vector obtained from a Gaussian mixture model representing speech;
determining a plurality of scores, wherein each score corresponds to one of the plurality of initial speech estimates and wherein each score is calculated from a joint distribution defined by a combination of one of the noise component vectors and one of the speech component vectors; and
determining a clean speech estimate as a combination of at least a subset of the plurality of scores, wherein a weight associated with a given score is the corresponding initial speech estimate that corresponds to the score.

2. The method of claim 1, wherein the spectrum of the input speech signal is represented by a vector that represents a frequency domain representation of a segment of a received speech signal.

3. The method of claim 2, further comprising:
dividing the received speech signal into segments of a predetermined duration; and
computing an N point transform for a segment to obtain the spectrum of the input speech signal vector, where N is an integer.

4. The method of claim 1, wherein the noise component vector is a mean vector of the Gaussian mixture model representing the noise.

5. The method of claim 1, wherein the speech component vector is a mean vector of the Gaussian mixture model representing speech.

6. The method of claim 1, further comprising:
estimating the Gaussian mixture model representing speech, such that a number of component distributions in the Gaussian mixture model representing speech is equal to or greater than a number of speech spectra used in determining the plurality of initial noise estimates.

7. The method of claim 1, further comprising:
estimating the Gaussian mixture model representing the noise, such that a number of component distributions in the Gaussian mixture model representing noise is equal to or greater than a number of noise spectra used in determining the plurality of initial speech estimates.

8. The method of claim 1, wherein determining the clean speech estimate further includes normalizing the weighted combination by a sum of the subset of the plurality of scores.

9. The method of claim 1, wherein the joint distribution is represented as a product of a first distribution represented by the corresponding speech component vector and a second distribution represented by the corresponding noise component vector.

10. The method of claim 9, wherein the score is evaluated as a product of a distribution value corresponding to an initial speech estimate and a distribution value corresponding to an initial noise estimate.

11. The method of claim 1, wherein each of the initial speech estimates are represented using absolute values of a difference between the spectrum of the input speech signal and the corresponding noise spectrum.

12. The method of claim 1, wherein each of the initial noise estimates is represented using absolute values corresponding to a difference between the spectrum of the input speech signal and the corresponding speech spectrum.

13. The method of claim 1, wherein subtracting the corresponding noise spectrum from the spectrum of the input speech signal further comprises:
raising at least one of the noise spectrum and the spectrum of the input speech signal to a power.

14. The method of claim 1, wherein subtracting the corresponding speech spectrum from the spectrum of the input speech signal further comprises
raising at least one of the speech spectrum and the spectrum of the input speech signal to a power.

15. A system comprising:
a speech recognition engine configured to:
receive an input speech signal comprising non-stationary noise;
determine a plurality of initial speech estimates by subtracting a plurality of noise spectra, respectively, from a spectrum of the input speech signal, wherein each of the noise spectra is represented by a noise component vector obtained from a Gaussian mixture model representing the non-stationary noise;
determine a plurality of initial noise estimates for the non-stationary noise by subtracting a plurality of speech spectra, respectively, from the spectrum of the input speech signal, wherein each of the speech spectra is represented by a speech component vector obtained from a Gaussian mixture model representing speech;
determine a plurality of scores, wherein each score corresponds to one of the plurality of initial speech estimates and wherein each score is calculated from a joint distribution defined by a combination of one of the noise component vectors and one of the speech component vectors; and
determine a clean speech estimate as a combination of at least a subset of the plurality of scores, wherein a weight associated with a given score is the corresponding initial speech estimate that corresponds to the score.

16. The system of claim 15, wherein the speech recognition engine is further configured to estimate the corresponds to representing speech, such that a number of component distributions in the Gaussian mixture model representing speech is equal to or greater than a number of speech spectra used in determining the plurality of initial noise estimates.

17. The system of claim 15, wherein the speech recognition engine is further configured to estimate the Gaussian mixture model representing the noise, such that a number of component distributions in the Gaussian mixture model representing the noise is equal to or greater than a number of noise spectra used in determining the plurality of initial speech estimates.

18. The system of claim 15, wherein the speech recognition engine is configured to normalize the weighted combination by a sum of the subset of the plurality of scores, and use the normalized weighted combination in determining the clean speech estimate.

19. The system of claim 15, wherein the speech recognition engine is further configured to raise at least one of the noise spectra, the speech spectra, and the spectrum of the input speech signal to a power.

20. A computer program product comprising computer readable instructions tangibly embodied in a non-transitory storage device, the instructions configured to cause one or more processors to:
receive an input speech signal comprising non-stationary noise;
determine a plurality of initial speech estimates by subtracting a plurality of noise spectra, respectively, from a spectrum of the input speech signal, wherein each of the noise spectra is represented by a noise component vector obtained from a Gaussian mixture model representing the noise;
determine a plurality of initial noise estimates for the non-stationary noise by subtracting a plurality of speech spectra, respectively, from the spectrum of the input speech signal, wherein each of the speech spectra is represented by a speech component vector obtained from a Gaussian mixture model representing speech;
determine a plurality of scores, wherein each score corresponds to one of the plurality of initial speech estimates and wherein each score is calculated from a joint distribution defined by a combination of one of the noise component vectors and one of the speech component vectors; and
determine a clean speech estimate as a combination of at least a subset of the plurality of scores, wherein a weight associated with a given score is the corresponding initial speech estimate that corresponds to the score.

21. The computer program product of claim 20, wherein the spectrum of the input speech signal is represented by a vector that represents a frequency domain representation of a segment of a received speech signal.

22. The computer program product of claim 21, further comprising instructions for:
dividing the received speech signal into segments of a predetermined duration; and computing an N point transform for a segment to obtain the spectrum of the input speech signal vector, where N is an integer.

23. The computer program product of claim 20, further comprising instructions for:
estimating the Gaussian mixture model representing speech, such that a number of component distributions in the Gaussian mixture model representing speech is equal to or greater than a number of speech spectra used in determining the plurality of initial noise estimates.

24. The computer program product of claim 20, further comprising instructions for:
estimating the Gaussian mixture model representing the noise, such that a number of component distributions in the Gaussian mixture model representing noise is equal to or greater than a number of noise spectra used in determining the plurality of initial speech estimates.

25. The computer program product of claim 20, further comprising instructions for determining the clean speech estimate by normalizing the weighted combination by a sum of the subset of the plurality of scores.

26. The computer program product of claim 20, wherein the joint distribution is represented as a product of a first distribution represented by the corresponding speech component vector and a second distribution represented by the corresponding noise component vector.

27. The computer program product of claim 20, wherein each of the initial speech estimates are represented using absolute values of a difference between the spectrum of the input speech signal and the corresponding noise spectrum.

28. The computer program product of claim 20, wherein each of the initial noise estimates is represented using absolute values corresponding to a difference between the spectrum of the input speech signal and the corresponding speech spectrum.

29. The computer program product of claim 20 comprising instructions for raising at least one of the noise spectra and the spectrum of the input speech signal to a power.

30. The computer program product of claim 20 comprising instructions for raising at least one of the speech spectra and the spectrum of the input speech signal to a power.
